(19) United States
(12) Patent Application Publication
(10) Pub. No.: US 2006/0062992 A1
(43) Pub. Date: Mar. 23, 2006

(54) Door elements with polyurethane foams for radiation protection

(75) Inventors: Thorsten Dreier, Dusseldorf (DE); Wolfgang Friederichs, Koln (DE); Heinz Pudleiner, Krefeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/188,686

(22) Filed: Jul. 25, 2005

(30) Foreign Application Priority Data
Jul. 29, 2004 (DE) 102004036756.6

(51) Int. Cl. B32B 5/22; B32B 3/26

(52) U.S. Cl. 428/318.6; 428/317.9

(57) ABSTRACT

The invention relates to door elements with radiation protection additive-containing polyurethane foams as a filling material for radiation protection, and to processes for their manufacture.

### FIELD OF THE INVENTION

The invention relates to door elements with polyurethane foams as a filling material for radiation protection, and to processes for their manufacture.

### BACKGROUND OF THE INVENTION

When operating X-ray devices or other apparatuses that emit ionizing radiation, measures are taken to protect the operator or third party from this radiation. Thus, for example, doors for radiation protection are used to shield X-ray rooms in medical practice. Said doors often contain metallic lead or lead compounds. Lead has the advantage of being readily available at low cost and being a good absorber of ionizing radiation, e.g. X-radiation, which is generated with accelerating voltages of 40 to 300 kV. The disadvantages of lead are that, as a result of the photoelectric effect, the attenuation factor of lead for lower-energy ionizing radiation is comparatively small. Also, lead is toxicologically harmful. Coupled with this is the high density of protective fittings containing lead.

Because of the high density of lead, the manufacture of doors for protection against X-radiation is complicated in terms of production engineering and demands specialized know-how. Doors for radiation protection that achieve the required radiation attenuation factor, expressed as the so-called “lead equivalent”, are available with sheet thicknesses of 0.5 mm to 3 mm. Door constructions equipped with such lead sheets have weights per unit area of approx. 33 kg/m² or more (calculated for a lead equivalent of 1 mm). Each additional millimeter of lead sheet increases this by approx. 13 kg/m². The choice of ties and frames is therefore particularly important. The higher the chosen lead equivalent of the door, the greater will be the structural complexity and the cost of the door ties and frames used.

There is therefore a need for door elements whose shielding properties against ionizing radiation are as good as those of door elements equipped with lead sheets, but which have a markedly lower density.

### SUMMARY OF THE INVENTION

Door elements satisfying these requirements have now been developed which are equipped with a rigid polyurethane or polyisocyanurate foam containing shielding material.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.”

The present invention provides a door element having facings between which there is a rigid polyurethane foam obtainable by reacting

a) an aromatic polyisocyanate with

b) a polyol component having an average of at least two isocyanate-reactive groups and containing at least one of a polyether polyol and a polyester polyol,

c) a radiation protection additive comprising,
c1) at least 26 wt. % and preferably 35-55 wt. %, based on the total amount c), of gadolinium,
c2) 10 to 74 wt. %, preferably 15 to 60 wt. % and particularly preferably 25 to 50 wt. %, based on the total amount c), of barium, indium, tin, molybdenum, niobium, tantalum, zirconium or tungsten, and
c3) 0 to 64 wt. %, preferably 20 to 50 wt. % and particularly preferably 25 to 40 wt. %, based on the total amount c), of bismuth, lanthanum, cerium, praseodymium, neodymium, promethium, samarium, europium, terbium, dysprosium, holmium, erbium, thulium, ytterbium or lutetium.

d) blowing agents,

e) optionally one or more of catalysts, auxiliary substances, additives, and flameproofing agents.

The present invention also provides processes for the manufacture of the door elements according to the invention. In the so-called “shell” construction technique, the required sections are produced by sawing or milling—the methods known from woodworking are basically suitable for this purpose—from rigid polyurethane or polyisocyanurate foam blocks containing the shielding material. The facings are then adhesively bonded thereto. Adhesives based on polyurethane, unsaturated polyester, epoxide, polyvinyl acetate or polychloroprene, inter alia, are suitable for this purpose. The action of pressure and temperature is required for curing, according to the type of adhesive. In the so-called “sandwich” construction technique, the reaction mixture is introduced into the cavity to be filled between the facings. On curing, it bonds to the facings. In specific cases, additional measures may be necessary to achieve good adhesion to the facings. Thus, for example, metal sheets can be provided with a primer to improve the adhesion.

Examples of aromatic polyisocyanates which can be used as isocyanate component a) are those described by W. Siefken in Justus Liebigs Analien der Chemie, 562, pages 75 to 136, for example those of the formula Q(NCO)ₙ, in which n=2 to 4, preferably 2, and Q is an aliphatic hydrocarbon radical having 2 to 18 and preferably 6 to 10 C atoms, a cycloaliphatic hydrocarbon radical having 4 to 15 and preferably 5 to 10 C atoms, or an aromatic hydrocarbon radical having 8 to 15 and preferably 8 to 13 C atoms, e.g. polyisocyanates such as those described in DE-OS 28 32 253, pages 10 and 11.

It is preferable to use the polyisocyanates that are readily available industrially, e.g. 2,4- and 2,6-toluylene diisocyanate and any desired mixtures of these isomers (“TDI”), polyphenylene-polymethylene polyisocyanates such as those prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially modified polyisocyanates derived from 2,4- and 2,6-toluylene diisocyanate or 4,4′- and/or 2,4′-diphenylmethane diisocyanate.

It is also possible to use prepolymers of said isocyanates and organic compounds having at least one hydroxyl group, for example polyether or polyester components having 1 to 4 hydroxyl groups and a molecular weight of 60 to 4,000. Both polyester polyols and polyether polyols can be used as polyol component b). The polyether polyols conventionally used have an OH number of 25 to 900 and preferably of 350 to 650.

Suitable polyether polyols can be prepared by reacting one or more alkylene oxides having 2 to 4 carbon atoms in the alkylene radical with a starter molecule having at least two active hydrogen atoms bonded to it. Alkylene oxides which may be mentioned are ethylene oxide, 1,2-propylene oxide, epichlorohydrin, 1,2-butylene oxide and 2,3-butylene oxide, it being preferable to use ethylene oxide, 1,2-propylene oxide and mixtures thereof. The alkylene oxides can be used individually, alternately in succession or as mixtures. It is thus possible, for example, to obtain polyether polyols built up in blocks from 1,2-propylene oxide and ethylene oxide. Examples of suitable starter molecules are water, amino alcohols such as N-alkyldiethanolamines, e.g. N-methyldiethanolamine, ethylene glycol, 1,3-propylene glycol, 1,4-butanediol, 1,6-hexanediol, glycerol, trimethylolpropane, sorbitol, sucrose, and primary aliphatic and aromatic amines. Optionally, it is also possible to use mixtures of starter molecules.

It is also possible to use polyester polyols having a number-average molecular weight of 100 to 30,000 g/mol, preferably of 150 to 10,000 g/mol and particularly preferably of 200 to 600 g/mol, made up of aromatic and/or aliphatic dicarboxylic acids and polyols having at least 2 hydroxyl groups. Examples of dicarboxylic acids are phthalic acid, fumaric acid, maleic acid, azelaic acid, glutaric acid, adipic acid, suberic acid, terephthalic acid, isophthalic acid, decanedicarboxylic acid, malonic acid and succinic acid. It is possible to use the pure dicarboxylic acids or any desired mixtures thereof. The following are preferably used as the alcohol component for the esterification: ethylene glycol, diethylene glycol, triethylene glycol, tetraethylene glycol, 1,2- or 1,3-propanediol, 1,4-butanediol, 3-methyl-1,5-pentanediol, 1,5-pentanediol, 1,6-hexanediol, 1,10-decanediol, glycerol, trimethylolpropane or mixtures thereof. The polyol components b) used can also contain polyetheresters such as those obtainable e.g. by the reaction of phthalic anhydride with diethylene glycol, followed by ethoxylation.

The radiation protection additive c) contains

c1) at least 26 wt. % and preferably 35 to 55 wt. % of gadolinium as the element or an alloy or in the form of gadolinium compounds;

c2) 10 to 74 wt. %, preferably 15 to 60 wt. % and particularly preferably 25 to 50 wt. % of barium, indium, tin, molybdenum, niobium, tantalum, zirconium or tungsten in the form of the elements or their alloys or compounds, the tungsten content, if tungsten is present, being at least 10 wt. % of the total amount c). Particular preference is given to barium, tin, tungsten or molybdenum. The radiation protection additive c) preferably contains less than 50 wt. % of tin; and

c3) 0 to 64 wt. %, preferably 20 to 50 wt. % and particularly preferably 25 to 40 wt. % of bismuth, lanthanum, cerium, praseodymium, neodymium, promethium, samarium, europium, terbium, dysprosium, holmium, erbium, thulium, ytterbium or lutetium in the form of the elements or their alloys or compounds, preferably in the form of their compounds. It is preferable to use bismuth, lanthanum, cerium, praseodymium, neodymium, samarium or europium. Particularly preferred compounds are the oxides.

Components c2) and c3) preferably are oxides, carbonates, sulfates, hydroxides, tungstates, carbides, sulfides or halides of said elements, the oxides, sulfates or tungstates being particularly preferred. Very particularly preferably, c2) is a compound chosen from barium sulfate, indium oxide and tin oxide or the metals tin, molybdenum, niobium, tantalum and zirconium, and c3) is a compound chosen from bismuth oxide, lanthanum oxide, cerium oxide, praseodymium oxide, promethium oxide, samarium oxide, europium oxide, terbium oxide, dysprosium oxide, holmium oxide, erbium oxide, thulium oxide, ytterbium oxide or lutetium oxide.

To prepare component c), the individual constituents are dried at temperatures ranging from 30 to 500° C. The individual constituents are subsequently screened with a sieve having a mesh size ranging from 3 to 125 μm, and then mixed for 5 minutes to 24 hours in mixers known to those skilled in the art, such as propeller, turbo, paddle, trough, planetary, attrition, screw, roller, centrifugal, contraflow, jet, drum, cone, tumbling, rotary, cooling, vacuum, pipeline, gravity, fluid and pneumatic mixers. It is preferable to use tumbling mixers. The density of the radiation protection additive c) ranges from 4.0 to 13.0 g/cm³ and preferably from 6.0 to 10 g/cm³.

The blowing agents d) used are water and/or other chemical or physical blowing agents known to those skilled in the art, e.g. methylene chloride, diethyl ether, acetone, alkanes such as pentane, i-pentane or cyclopentane, fluorocarbons such as HFC 245fa or HFC 365mfc, or inorganic blowing agents such as air or CO₂. If water is used as the blowing agent, it is preferably used in an amount of 6 parts by weight, based on the total weight of component b).

Catalysts and other auxiliary substances and additives for the preparation of rigid polyurethane foams are known to those skilled in the art and are described e.g. in “Kunststoffhandbuch”, volume 7 “Polyurethane”, chapter 6.1.

The catalysts used can be those conventionally employed in polyurethane chemistry. Examples of such catalysts are triethylenediamine, N,N-dimethylcyclohexylamine, tetramethylenediamine, 1-methyl-4-dimethylaminoethylpiperazine, triethylamine, tributylamine, dimethylbenzylamine, N,N′,N″-tris(dimethylaminopropyl)hexahydrotriazine, dimethylaminopropylformamide, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin(II) acetate, tin(II) octoate, tin(II) ethylhexanoate, tin(II) laurate, dibutyltin diacetate, dibutyltin dilaurate, dibutyltin maleate, dioctyltin diacetate, tetramethylammonium hydroxide, sodium acetate, potassium acetate, sodium hydroxide or mixtures of these catalysts.

Particularly suitable foam stabilizers are polyethersiloxanes. These compounds are generally synthesized in such a way that a copolymer of ethylene oxide and propylene oxide is bonded to a polydimethylsiloxane residue. Flameproofing agents are known to those skilled in the art and are described e.g. in “Kunststoffhandbuch”, volume 7 “Polyurethane”, chapter 6.1. These can be e.g. bromine-containing and chlorine-containing polyols, or phosphorus compounds such as orthophosphoric and metaphosphoric acid esters, which also contain halogen.

The foams used in the process according to the invention are conventionally prepared by intimately mixing the diisocyanate or polyisocyanate a), as one component, and a mixture of the remaining constituents, as the other component, by means of a suitable device (conventionally mechanical). The foams can be prepared either continuously, for instance on a conveyor belt system, or batchwise. The preparation of rigid foams is known in principle to those skilled in the art and is described e.g. in G. Oertel (ed.) “Kunststoff-Handbuch”, volume VII, Carl Hanser Verlag, 3rd edition, Munich 1993, p. 267 et seq. The index—a concept very frequently used in the preparation of polyurethane foams—says something about the degree of crosslinking of a foam. It is defined as the ratio of the isocyanate groups to the isocyanate-reactive groups in the reaction mixture, multiplied by 100. Preferably, the foams are prepared in such a way as to give an index of 80 to 600 and preferably of 100 to 300. The bulk density of the foams formed is 10 to 500 kg/m³, preferably 30 to 300 kg/m³ and particularly preferably 60 to 150 kg/m³.

### EXAMPLES

The present invention is further illustrated, but is not to be limited, by the following examples. All quantities given in “parts” and “percents” are understood to be by weight, unless otherwise indicated.

A rigid polyurethane foam was prepared in each case by reacting the components indicated in Table I below:

TABLE I

| | C-1 | Ex. 2 | Ex. 3 | C-4 | Ex. 5 | Ex. 6 |
|---|---|---|---|---|---|---|
| | (pbw) | (pbw) | (pbw) | (pbw) | (pbw) | (pbw) |
| Polyol | 100 | 100 | 100 | 100 | 100 | 100 |
| Water | 1.1 | 1.1 | 1.1 | 0.8 | 1.27 | 1.29 |
| Cyclohexylamine | 1.8 | 1.8 | 1.8 | 1.09 | 1.61 | 1.21 |
| Radiation protection additive | — | 26.8 | 60.3 | — | 99.3 | 154.5 |
| Pentane | 9.95 | 12.44 | 15.52 | — | — | — |
| Polyisocyanate | 138.1 | 138.1 | 138.1 | 120.75 | 128.77 | 129.25 |
| Proportion of radiation | 0 | 10 | 20 | 0 | 30 | 40 |
| protection additive [wt. %] | | | | | | |
| Bulk density [kg/m³] | 30 | 30 | 30 | 120 | 120 | 120 |

The polyisocyanate used was a mixture of MDI isomers and their higher homologues with an NCO content of 31 wt. % (DESMODUR 44V40L, Bayer MaterialScience AG).

The polyol used was a polyetherester mixture with an OH number of 385, a functionality of 3.3 and a viscosity of 2,000 mPa s at 25° C. (BAYMER, VP.PU 22HB16, Bayer MaterialScience AG).

The radiation protection additive was an orange-brown, free-flowing, lump-free powder with a density of 8.5 g/cm³, containing the following components in the amounts specified below in Table II:

TABLE II

| Component | wt. %, | Component | wt. %, |
|---|---|---|---|
| Gd₂O₃ | 36.9 | W | 31.5 |
| La₂O₃ | 7.1 | CeO₂ | 16.1 |
| Pr₆O₁₁ | 1.2 | Nd₂O₃ | 4.3 |
| Sm₂O₃ | 0.6 | Eu₂O₃ | 0.4 |
| Tb₂O₃ | 0.2 | Dy₂O₃ | 0.2 |

To determine the shielding effect, step wedges (width: 7.5 cm, height of steps: 1.25 cm/2.5 cm/5.0 cm/10.0 cm/12.5 cm, length of each step: 4 cm) were sawn from the specimens produced. This gave surfaces with a different thickness and hence in each case with a different mass coverage of the radiation protection additive c). The step wedges were exposed to 100 kV X-radiation (X-ray tubes with tungsten anticathode) according to DIN 6845 and the exposed X-ray films were evaluated by densitometry. The less darkening there is, the better is the shielding effect. To relate the results of the irradiation experiments to a parameter standardized to the sample density and the filler content of the foam in the sample, the mass coverage was defined as follows:

$$\text{mass coverage} = \text{sample density} [ \text{g} \text{/} {cm}^{3} ] \times \text{filler content of foam} [ \text{wt} . \% ] \times \frac{\text{sample thickness} [ cm ]}{100}$$

The results of the measurements are collated in Tables III through VI below.

TABLE III

| Comparative Example 1 | | | Comparative Example 4 | | |
|---|---|---|---|---|---|
| Specimen | Mass | Darkening | Specimen | Mass | Darkening |
| thickness | coverage | [relative | thickness | coverage | [relative |
| [mm] | [g/cm²] | units] | [mm] | [g/cm²] | units] |
| 12.5 | 0 | 6.50 | 12.5 | 0 | 6.50 |
| 25 | 0 | 6.50 | 25 | 0 | 6.50 |
| 50 | 0 | 6.50 | 50 | 0 | 5.36 |
| 100 | 0 | 5.92 | 100 | 0 | 3.96 |
| 125 | 0 | 5.36 | 125 | 0 | 3.47 |

TABLE IV
Comparative Example (lead)

| Specimen | Mass | |
|---|---|---|
| thickness | coverage | Darkening |
| [mm] | [g/cm²] | [relative units] |
| 0.1 | 0.11 | 4.98 |
| 0.2 | 0.23 | 3.63 |
| 0.3 | 0.34 | 2.87 |
| 0.4 | 0.45 | 2.42 |
| 0.5 | 0.56 | 1.87 |
| 0.6 | 0.68 | 1.56 |
| 0.7 | 0.8 | 1.33 |
| 0.8 | 0.9 | 1.15 |
| 0.9 | 1.02 | 0.99 |
| 1 | 1.13 | 0.89 |

TABLE V

| Example 2 | | | Example 3 | | |
|---|---|---|---|---|---|
| Specimen | Mass | Darkening | Specimen | Mass | Darkening |
| thickness | coverage | [relative | thickness | coverage | [relative |
| [mm] | [g/cm²] | units] | [mm] | [g/cm²] | units] |
| 12.5 | 0.00375 | 6.50 | 12.5 | 0.0075 | 6.50 |
| 25 | 0.0075 | 6.44 | 25 | 0.015 | 6.00 |
| 50 | 0.015 | 5.61 | 50 | 0.03 | 4.80 |
| 100 | 0.03 | 4.59 | 100 | 0.06 | 3.53 |
| 125 | 0.0375 | 4.26 | 125 | 0.075 | 3.07 |

TABLE VI

| Example 5 | | | Example 6 | | |
|---|---|---|---|---|---|
| Specimen | Mass | Darkening | Specimen | Mass | Darkening |
| thickness | coverage | [relative | thickness | coverage | [relative |
| [mm] | [g/cm²] | units] | [mm] | [g/cm²] | units] |
| 12.5 | 0.045 | 4.61 | 12.5 | 0.06 | 4 |
| 25 | 0.09 | 3.26 | 25 | 0.12 | 2.66 |
| 50 | 0.18 | 1.81 | 50 | 0.24 | 1.25 |
| 100 | 0.36 | 0.74 | 100 | 0.48 | 0.46 |
| 125 | 0.45 | 0.49 | 125 | 0.6 | 0.34 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A door element comprising two or more facings having disposed therebetween a rigid polyurethane foam which is the reaction product of:
a) at least one aromatic polyisocyanate;
b) a polyol component having an average of at least two isocyanate-reactive groups and containing at least one of a polyether polyol and a polyester polyol;
c) a radiation protection additive comprising,
c1) at least about 26 wt. %, based on the total amount c), of gadolinium,
c2) about 10 to about 74 wt. %, based on the total amount c), of barium, indium, tin, molybdenum, niobium, tantalum, zirconium or tungsten, and
c3) about 0 to about 64 wt. %, based on the total amount c), of bismuth, lanthanum, cerium, praseodymium, neodymium, prometheus, samarium, europium, terbium, dysprosium, holmium, erbium, thulium, ytterbium or lutetium; and
d) a blowing agent,
e) optionally, one or more chosen from catalysts, auxiliary substances, additives and flameproofing agents.

2. The door element according to claim 1, wherein c1) comprises about 35 to about 55 wt. % of the radiation protection additive.

3. The door element according to claim 1, wherein c2) comprises about 15 to about 60 wt. % of the radiation protection additive.

4. The door element according to claim 1, wherein c2) comprises about 25 to about 50 wt. % of the radiation protection additive.

5. The door element according to claim 1, wherein c2) is chosen from barium sulfate, indium oxide, tin oxide, tin, molybdenum, niobium, tantalum and zirconium metals.

6. The door element according to claim 1, wherein c3) comprises about 20 to about 50 wt. % of the radiation protection additive.

7. The door element according to claim 1, wherein c3) comprises about 25 to about 40 wt. % of the radiation protection additive.

8. The door element according to claim 1, wherein c3) is chosen from bismuth oxide, lanthanum oxide, cerium oxide, praseodymium oxide, promethium oxide, samarium oxide, europium oxide, terbium oxide, dysprosium oxide, holmium oxide, erbium oxide, thulium oxide, ytterbium oxide and lutetium oxide.

9. A process for the manufacture of door element comprising: producing a rigid polyurethane foam block by reacting,
a) at least one aromatic polyisocyanate,
b) a polyol component having an average of at least two isocyanate-reactive groups and containing at least one of a polyether polyol and a polyester polyol,
c) a radiation protection additive comprising,
c1) at least about 26 wt. %, based on the total amount c), of gadolinium,
c2) about 10 to about 74 wt. %, based on the total amount c), of barium, indium, tin, molybdenum, niobium, tantalum, zirconium or tungsten, and
c3) about 0 to about 64 wt. %, based on the total amount c), of bismuth, lanthanum, cerium, praseodymium, neodymium, promethium, samarium, europium, terbium, dysprosium, holmium, erbium, thulium, ytterbium or lutetium
d) a blowing agent,
e) optionally, one or more chosen from catalysts, auxiliary substances, additives and flameproofing agents;
cutting the block to size; and
adhesively bonding two or more facings to the block.

10. The process according to claim 9, wherein cl) comprises about 35 to about 55 wt. % of the radiation protection additive.

11. The process according to claim 9, wherein c2) comprises about 15 to about 60 wt. % of the radiation protection additive.

12. The process according to claim 9, wherein c2) comprises about 25 to about 50 wt. % of the radiation protection additive.

13. The process according to claim 9, wherein c2) is chosen from barium sulfate, indium oxide, tin oxide, tin, molybdenum, niobium, tantalum and zirconium metals.

14. The process according to claim 9, wherein c3) comprises about 20 to about 50 wt. % of the radiation protection additive.

15. The process according to claim 9, wherein c3) comprises about 25 to about 40 wt. % of the radiation protection additive.

16. The process according to claim 9, wherein c3) is chosen from bismuth oxide, lanthanum oxide, cerium oxide, praseodymium oxide, promethium oxide, samarium oxide, europium oxide, terbium oxide, dysprosium oxide, holmium oxide, erbium oxide, thulium oxide, ytterbium oxide and lutetium oxide.

17. A process for the manufacture of a door element comprising: introducing between two or more facings a reaction mixture comprising,
a) at least one aromatic polyisocyanate,
b) a polyol component having an average of at least two isocyanate-reactive groups and containing at least one of a polyether polyol and a polyester polyol,
c) a radiation protection additive comprising,
c1) at least about 26 wt. %, based on the total amount c), of gadolinium,
c2) about 10 to about 74 wt. %, based on the total amount c), of barium, indium, tin, molybdenum, niobium, tantalum, zirconium or tungsten, and
c3) about 0 to about 64 wt. %, based on the total amount c), of bismuth, lanthanum, cerium, praseodymium, neodymium, promethium, samarium, europium, terbium, dysprosium, holmium, erbium, thulium, ytterbium or lutetium
d) a blowing agent,
e) optionally, one or more chosen from catalysts, auxiliary substances, additives and flameproofing agents; and
curing the mixture.

18. The process according to claim 17, wherein c1) comprises about 35 to about 55 wt. % of the radiation protection additive.

19. The process according to claim 17, wherein c2) comprises about 15 to about 60 wt. % of the radiation protection additive.

20. The process according to claim 17, wherein c2) comprises about 25 to about 50 wt. % of the radiation protection additive.

21. The process according to claim 17, wherein c2) is chosen from barium sulfate, indium oxide, tin oxide, tin, molybdenum, niobium, tantalum and zirconium metals.

22. The process according to claim 17, wherein c3) comprises about 20 to about 50 wt. % of the radiation protection additive.

23. The process according to claim 17, wherein c3) comprises about 25 to about 40 wt. % of the radiation protection additive.

24. The process according to claim 17, wherein c3) is chosen from bismuth oxide, lanthanum oxide, cerium oxide, praseodymium oxide, promethium oxide, samarium oxide, europium oxide, terbium oxide, dysprosium oxide, holmium oxide, erbium oxide, thulium oxide, ytterbium oxide and lutetium oxide.
